(19) United States
(12) Patent Application Publication
(10) Pub. No.: US 2013/0299132 A1
(43) Pub. Date: Nov. 14, 2013

(54) HEAT EXCHANGER ASSEMBLY AND METHOD OF MANUFACTURING THEREFOR

(71) Applicant: Blissfield Manufacturing Company, Blissfield, MI (US)

(72) Inventor: Dallas Guilford, Delta, OH (US)

(73) Assignee: Blissfield Manufacturing Company, Blissfield, MI (US)

(21) Appl. No.: 13/892,597

(22) Filed: May 13, 2013

Related U.S. Application Data
(60) Provisional application No. 61/646,656, filed on May 14, 2012.

(51) Int. Cl. F28F 1/00; B23P 15/26

(52) U.S. Cl. CPC F28F 1/00; B23P 15/26
USPC 165/67; 29/890.03

(57) ABSTRACT

Heat exchanger assemblies and manufacturing methods that are capable of promoting continuously downward and/or horizontal flow of fluids through a coolant tube of a heat exchanger assemble to reduce the risk of internal clogging. The heat exchanger assembly includes at least one coil adapted to contain a fluid therein and at least two support members supporting the coil. The coil is formed of at least one tube having an inlet at an uppermost extent thereof, an outlet at a lowermost extent thereof, a plurality of parallel horizontal rows, and a plurality of bends at opposite ends of the horizontal rows and fluidically interconnecting the horizontal rows thereof in series to define a serpentine configuration. The coil is adapted to achieve a continuously downward and/or horizontal flow of the fluid therein.

### CROSS REFERENCE TO RELATED APPLICATIONS

This application claims the benefit of U.S. Provisional Application No. 61/646,656, filed May 14, 2012, the contents of which are incorporated herein by reference.

### BACKGROUND OF THE INVENTION

The present invention generally relates to heat exchangers. More particularly, this invention relates to heat exchangers adapted to promote continuous downward flow of fluids through a coolant tube thereof to reduce the risk of internal clogging within the tube.

Heat exchangers are widely used in various industries in the form of radiators for cooling motors, engines, and steering, transmission and hydraulic fluids, condensers and evaporators for use in air conditioning systems, and heaters. In their most simple form, heat exchangers include one or more passages through which a fluid flows while exchanging heat with the environment surrounding the passage. In order to efficiently maximize the amount of surface area available for transferring heat between the environment and fluid, the design of a heat exchanger is typically of a tube-and-fin type containing a number of tubes that thermally communicate with fins. The fins enhance the ability of the heat exchanger to transfer heat from the fluid to the environment, or vice versa. Various heat exchanger designs are known in the art. Design variations include the manner in which the fluid passage is constructed and the type of fin used. For example, the passage may be composed of one or more serpentine tubes that traverse the heat exchanger in a circuitous manner, or a number of discrete parallel tubes joined, typically brazed, to and between a pair of headers. The fins may be provided in the form of panels having apertures through which the tubes are inserted, or in the form of centers that can be positioned between adjacent pairs of tubes.

In traditional serpentine heat exchangers, a refrigerant flows up and down through a tube (coil) across the heat exchanger (“up,” “down” and similar terms are used herein to refer to the orientation of a heat exchanger to earth, and are therefore relative terms that indicate the construction, installation and intended use of a heat exchanger). The flow path of traditional serpentine heat exchangers often allow for puddling of refrigerant in low spots of the coil which reduces the efficiency of the heat exchanger and may cause clogging within the coil. Furthermore, crossovers and manifolds in traditional serpentine heat exchangers can create leak paths in the coil, further reducing the performance of the heat exchanger.

Accordingly, there is a need for heat exchanger assemblies capable of reducing clogging within their assemblies.

BRIEF DESCRIPTION OF THE INVENTION

The present invention provides heat exchanger assemblies and manufacturing methods that are capable of promoting continuously downward and/or horizontal flow of fluids through a coolant tube of a heat exchanger assemble to reduce the risk of internal clogging.

According to a first aspect of the invention, a heat exchanger assembly includes at least one coil adapted to contain a fluid therein and at least two support members supporting the coil. The coil is formed of at least one tube having an inlet at an uppermost extent thereof, an outlet at a lowermost extent thereof, a plurality of parallel horizontal rows, and a plurality of bends at opposite ends of the horizontal rows and fluidically interconnecting the horizontal rows thereof in series to define a serpentine configuration. The coil is adapted to achieve a continuously downward and/or horizontal flow of the fluid therein.

According to a second aspect of the invention, a method of manufacturing a heat exchanger assembly includes bending a tube to form a serpentine shaped tube defined by a plurality of horizontal tube portions in a vertical plane and a plurality of vertical bends at opposite ends of the tube portions and fluidically interconnecting the horizontal tube portions thereof in series. The serpentine shaped tube has an inlet at an uppermost extent thereof and an outlet at a lowermost extent thereof. The serpentine shaped tube is bent about a center axis located at a longitudinal midpoint along the horizontal tube portions to form a coil defined by a plurality of horizontal bends at a first end and the plurality of vertical bends at a second end oppositely disposed from the first end. The plurality of vertical bends defining a first vertical column of vertical bends in a first vertical plane and a second vertical column of vertical bends in a second vertical plane adjacent and parallel to the first column. Each of the plurality of vertical bends in the first column of vertical bends is twisted about axes parallel to longitudinal axes of the horizontal tube portions counter clockwise and twisting each of the plurality of vertical bends in the second column of vertical bends about axes parallel to longitudinal axes of the horizontal tube portions clockwise. A first support member is secured to the first end of the coil and then a second support member is secured to the second end of the coil oppositely-disposed from the first end of the coil.

According to a third aspect of the invention, a heat exchanger assembly includes at least one coil and at least two support members supporting the coil. The coil is adapted to contain a fluid therein and formed of at least one tube includes an inlet at an uppermost extent thereof and an outlet at a lowermost extent thereof. The coil includes a plurality of parallel horizontal rows and a plurality of bends at opposite ends of the horizontal rows and fluidically interconnecting the horizontal rows thereof in series to define a serpentine configuration. The coil is defined by adjacent at least first and second vertical columns each comprising at least one pair of the horizontal rows and the first and second vertical columns are adjacent each other and nested so that the horizontal rows of the first column and the horizontal rows of the second column are interdigitated with each other.

A technical effect of the invention is the ability to reduce clogging in heat exchanger assemblies. In particular, it is believed that, by forming a coil of a heat exchanger assembly to have a continuously downward and/or horizontal flow path, puddling of a coolant flowing through the coil may be substantially reduced relative to conventional heat exchanger assemblies.

Other aspects and advantages of this invention will be better appreciated from the following detailed description.

### BRIEF DESCRIPTION OF THE DRAWINGS

FIG. 1 is a perspective view representing a heat exchanger assembly in accordance with an aspect of the present invention.

FIG. 2 is a perspective view representing a heat exchanger assembly in accordance with another aspect of the present invention.

FIG. 3 is a perspective view representing a heat exchanger assembly in accordance with yet another aspect of the present invention.

FIGS. 4, 5, 6, and 7 are front, bottom, and opposite end views, respectively, representing the heat exchanger assembly of FIG. 3.

FIGS. 8 and 9 are perspective and side views, respectively, representing a tube bent into a serpentine shape during a manufacturing step for producing a coil similar to that represented in the heat exchanger assembly of FIGS. 1-6.

FIG. 10 is a schematic end view representing the tube of FIGS. 8 and 9 after it has been bent along the center line C₁.

FIG. 11 is a schematic end view representing the tube of FIG. 10 after vertical bends, represented in FIGS. 8 through 10, have been twisted in accordance with an aspect of this invention.

FIGS. 12, 13, 14, and 15 are perspective, side, and opposite end views, respectively, representing a coil similar to that represented in the heat exchanger assemblies of FIGS. 1-6.

### DETAILED DESCRIPTION OF THE INVENTION

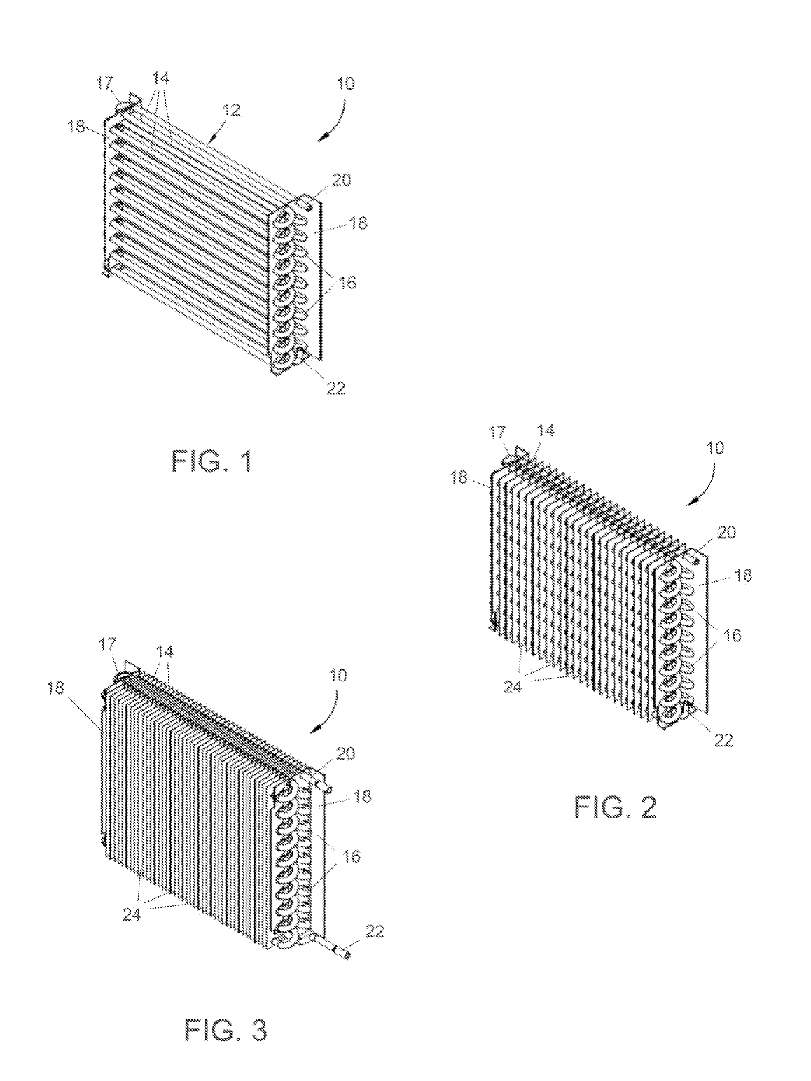

FIGS. 1 through 6 represent non-limiting embodiments of nested herringbone down-flow heat exchanger assemblies 10 of the present invention. Each heat exchanger assembly 10 is adapted to contain a fluid within at least one coil 12 for promoting heat exchange between the fluid and the environment surrounding the coil 12. Suitable fluids include, but are not limited to, CO₂, propane, and other gasses and liquids capable of use for heat exchange. The heat exchanger assemblies 10 may be formed of any suitable material, for example, ferrous metals, non-ferrous metals, plastics, and glass materials. For convenience, in addition to each heat exchanger assembly being identified by the reference number 10, consistent reference numbers are used throughout the figures to identify the same or functionally equivalent elements. To facilitate the description of the heat exchanger assemblies 10, the terms “up,” “down,” “upper,” “lower,” “front,” “back,” “side,” “above,” “below,” etc., are used herein to refer to the orientation of a heat exchanger assembly 10 to earth, and are relative terms that indicate the construction, installation and use of a heat exchanger, and therefore help to define the scope of the invention.

Each of the heat exchanger assemblies 10 is represented in FIGS. 1 through 6 as comprising a continuous tube that defines a coil 12. The tube is folded in such a way that fluid therein flows continuously downward and/or horizontally through the coil 12 in a manner that is capable of reducing clogging within the coil 12 relative to conventional heat exchangers. The coil 12 includes an inlet 20 at an uppermost extent of the coil 12 and an outlet 22 at a lowermost extent of the coil 12. The coil 12 is represented as being supported by two support members 18 at opposite ends of the coil 12. The support members 18 may comprise flanges to secure the heat exchanger assembly 10 to another structure, for example, to a frame of a motor vehicle. The flanges may be constructed in any shape suitable for the intended application. Additional support members 18 may be included in order to support the coil 12 and/or secure the heat exchanger assembly 10 to the structure.

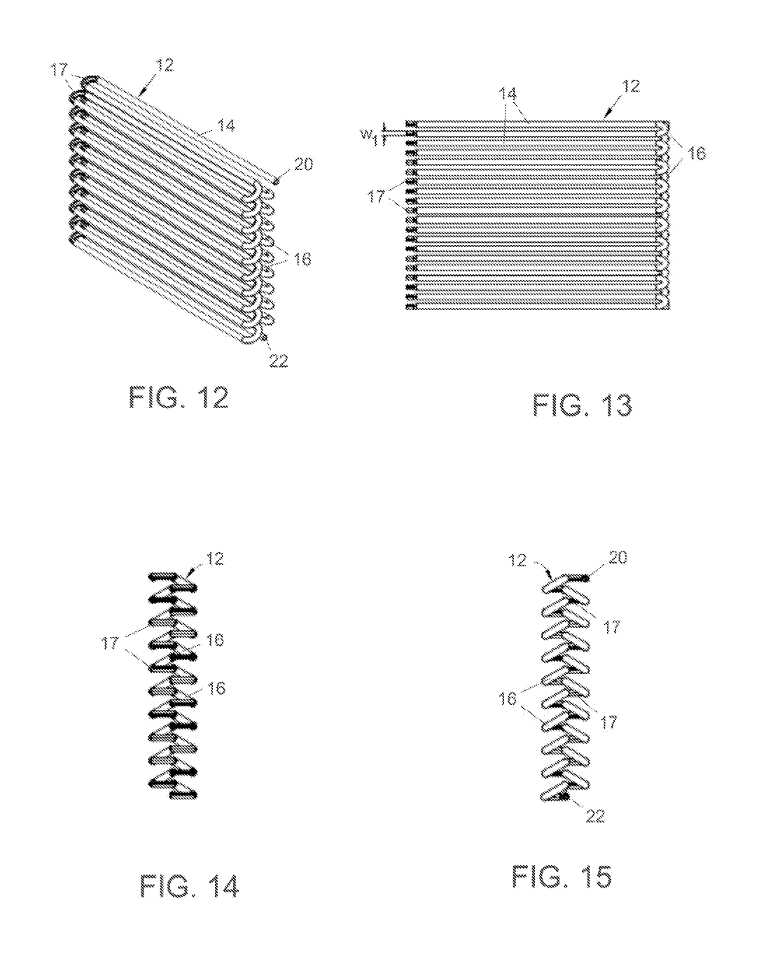

As more readily evident from FIG. 12, the coil 12 is defined by a plurality of parallel horizontal rows 14 and a plurality of bends 16 and 17 at opposite ends of the horizontal rows 14. The bends 16 and 17 fluidically interconnect the horizontal rows 14 in series to define a nested serpentine pattern. A first end of the coil 12 comprises horizontal bends 17 (FIG. 13) and a second end of the coil 12 oppositely-disposed from the first end comprises a first and second set of alternating downward bends 16, with each of the sets of downward bends 16 being vertically aligned to define what can be described as a vertical column (FIG. 15). The first set of downward bends 16 are bent in a direction downward and away from the second set of downward bends 16. Likewise, the second set of downward bends 16 are bent in a direction downward and away from the first set of downward bends 16. The first and second sets of downward bends 16 are alternating to form a herringbone pattern. The downward bends 16 promote a continuously downward and/or horizontal flow of fluid from the inlet 20 to the outlet 22 of the coil 12. The downward bends 16 are represented in FIGS. 1 through 3, 7, 12, 14, and 15 as angled in a direction towards the outlet 22 of the coil 12.

Preferably, the horizontal rows 14 of the coil 12 are nested. For example, FIG. 12 represents the coil 12 as including two adjacent columns comprising pairs of horizontal rows 14. Each pair of horizontal rows 14 includes an exterior horizontal row located at an exterior extent of the coil 12 and an interior row located at an interior extent of the coil 12. The interior rows of the pairs of horizontal rows 14 overlap one another and, as evident from FIGS. 12 and 15, are preferably aligned to lie in a vertical plane. Alternatively, the pairs of horizontal rows 14 may be interdigitated with each other, that is, having at least some of the horizontal rows 14 from the first column disposed between adjacent pairs of the horizontal rows 14 of the second column adjacent to the first column. It is believed that nesting the horizontal rows 14 of the coil 12 in a manner such as that shown in the figures allows a longer flow path to fit in the same amount of space thereby promoting an increased rate of heat transfer between the fluid within the coil 12 and the environment surrounding the coil 12 in comparison to other heat exchangers of equal size.

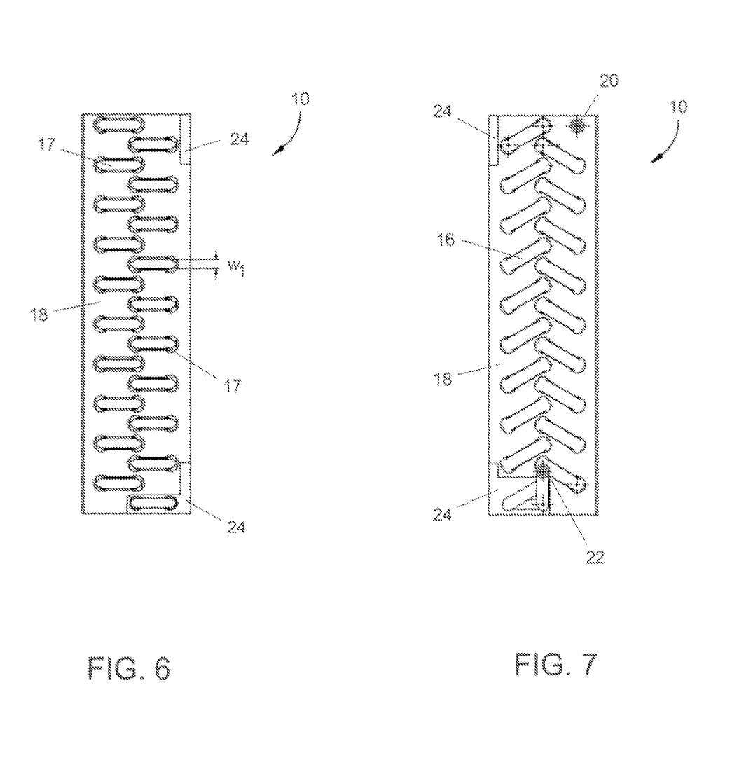

The coil 12 represented in FIGS. 12 through 15 can be fabricated to have an appropriate wall thickness suitable for use in either standard and high pressure applications. The coil 12 could be made of any suitable material or materials including, but not limited to, steel, stainless steel, copper, polymer, glass and/or aluminum. The coil 12 can be made to have a suitable outside diameter, for example, in a range of about 0.2 inch to about one inch (about 5 to about 25 millimeters), though other dimensions are foreseeable. As a non-limiting example, it is believed that a coil 12 formed of carbon steel having an outside diameter of about 0.375 inch (about 9.5 mm) and a wall thickness of about 0.028 inch (about 0.71 mm) can be suitable for use in operating pressures up to about 2,200 psi (15.2 Mpa). Connectors (not shown) may be attached to the inlet 20 and/or outlet 22, for example, copper connectors. The horizontal bends 17 may optionally be flattened to have a width w₁ as represented in FIG. 6. The heat exchanger assembly 10 may further be modified for particular applications by changing the number of horizontal rows 14 in the coil 12, changing the number of columns in which the horizontal rows 14 are aligned, and/or changing the radius and the degree of twist of the bends 16 and 17 in the coil 12.

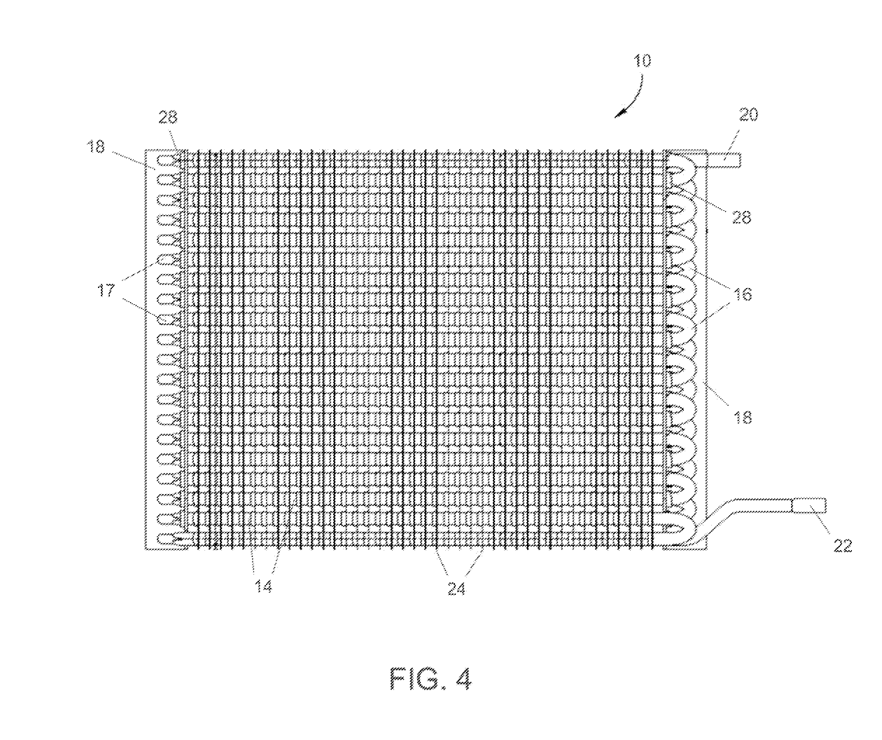

In the perspective view of the heat exchanger assembly 10 represented in FIG. 1, the heat exchanger assembly 10 is shown without fins. To improve heat transfer, one or more fins 24 may be attached to the coil 12, as represented in FIGS. 2 through 7. FIGS. 4, 5, 6, and 7 represent side, bottom, and opposite end views, respectively, of the heat exchanger assembly 10 of FIG. 3. The number of fins 24 attached to the coil 12 may be limited to reduce the likelihood of clogging within the coil 12. Various fin designs may be used to increase performance of the heat exchanger assembly 10 including, but not limited to, straight, corrugated and lanced fin designs. The fins 24 may be made of any suitable material such as steel, stainless steel, copper, aluminum, galvanized steel or a polymer material. Further, the fins 24 may have a finish coating such as a hydrophilic, latex, or electrodeposition coating. Depending on the application, it may be desirable to limit the number of fins 24 attached to the coil 12. It is believed that addition of the fins 24 to the heat exchanger assembly 10 increases the likelihood of debris from an outside environment accumulating around the coil 12 which may act to insulate the coil 12 reducing the rate of heat transfer of the heat exchanger assembly 10.

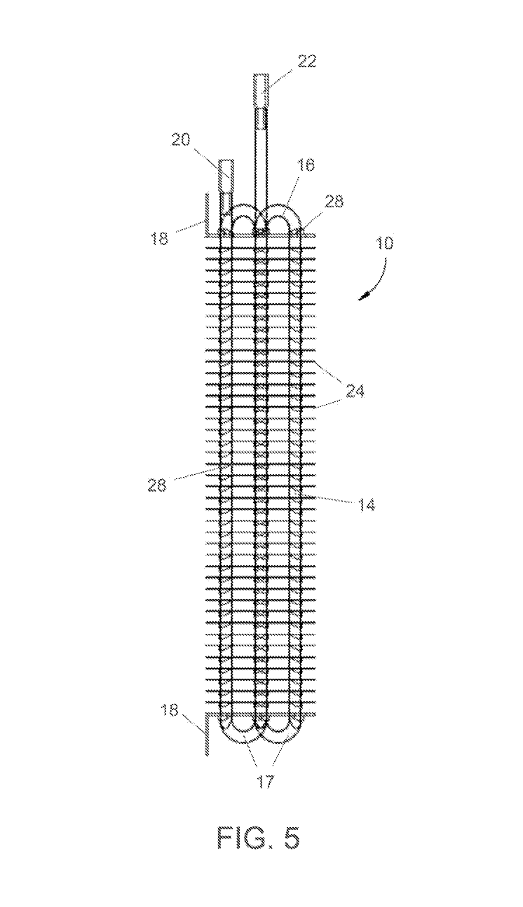

As represented in FIGS. 4 and 5, the support members 18 and/or the fins 24 may comprise extrusions 28 that encircle and contact the coil 12. The extrusions 28 allow for increased surface area contact between the coil and support members 18 and/or the fins 24 thereby increasing thermal transfer. The extrusions 28 may further promote accurate fin spacing and support member alignment.

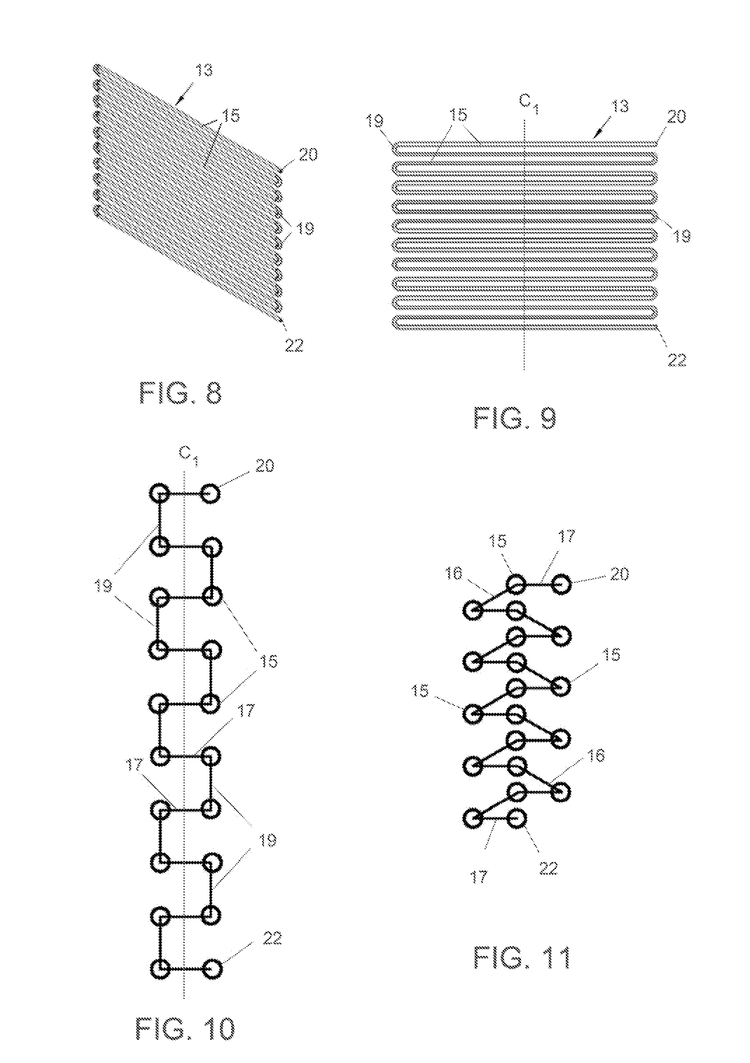

FIGS. 8 through 11 represent a method of manufacturing the coil 12 of the heat exchanger assembly 10. In FIG. 8, a straight tube has been bent to form a serpentine shaped tube 13 comprising a plurality of horizontal tube portions 15 lying entirely in a single plane and fluidically connected by vertical bends 19 at opposing ends of the tube portions 15. The tube 13 is bent at a midpoint of the tube portions 15 along a center line (C₁) represented in FIG. 9 resulting in formation of the horizontal bends 17 formed about the center line C₁ and repositioning of all of the vertical bends 19 to be disposed at one end of the tube 13 opposite the newly formed horizontal bends 17. At this point, the horizontal bends 17 may optionally be flattened. The vertical bends 19 define a first column of vertical bends 19 in a first vertical plane and a second column of vertical bends 19 in a second vertical plane adjacent and parallel to the first column. FIG. 10 is a schematic representation of an end of the tube 13 after being bent along the center line C₁ and represents the tube portions 15 being disposed in a direction extending into the plane of the page. It should be noted that FIGS. 10 and 11 are for illustrative purposes only and are not to scale and do not represent the same number of horizontal bends 17, vertical bends 19, and tube portions 15 as FIGS. 8 and 9.

The herringbone pattern of the coil 10 may then be formed by twisting all of the vertical bends 19 in the first column counter clockwise and all of the vertical bends 19 in the second column clockwise. Each vertical bend 19 is twisted in either a clockwise or counter clockwise direction about an axis parallel to a longitudinal axis of the tube portions 15. FIG. 11 schematically represents the end of the tube 13 of FIG. 10 after the vertical bends 19 have been twisted to form the herringbone pattern. To achieve the herringbone pattern, the vertical bends 19 are twisted in a repeating order starting with a first vertical bend 19, represented in FIG. 10 as an uppermost vertical bend 19, continuing to a second vertical bend 19 immediately below the first vertical bend 19, and continuing through the plurality of vertical bends 19 in series until all of the vertical bends 19 have been twisted either counter clockwise or clockwise.

The repeating order includes twisting the first vertical bend 19 counter clockwise (about 60 degrees), twisting the second vertical bend 19 clockwise (about 60 degrees), twisting a third vertical bend 19 counter clockwise (about 60 degrees), and twisting a fourth vertical bend 19 clockwise (about 60 degrees). This alternating sequence of counter clockwise and clockwise twists is continued until all of the vertical bends 19 have been twisted and the herringbone pattern has been formed on the entirety of the coil 12 resulting in a coil shape similar to that shown in FIGS. 12 through 15. Once the coil 12 has been formed, the support members 18 and the fins 24 may be secured to the coil 12 to form the heat exchanger assembly 10.

While the invention has been described in terms of specific embodiments, it is apparent that other forms could be adopted by one skilled in the art. For example, the physical configuration of the heat exchanger assemblies 10 could differ from those shown, and materials and processes other than those noted could be used. Therefore, the scope of the invention is to be limited only by the following claims.

1. A heat exchanger assembly comprising:
at least one coil adapted to contain a fluid therein and being formed of at least one tube comprising:
an inlet at an uppermost extent thereof,
an outlet at a lowermost extent thereof,
a plurality of parallel horizontal rows,
a plurality of bends at opposite ends of the horizontal rows and fluidically interconnecting the horizontal rows thereof in series to define a serpentine configuration, and
at least two support members supporting the coil, wherein the coil is adapted to achieve a continuously downward and/or horizontal flow of the fluid therein.

2. The heat exchanger assembly of claim 1, wherein at least a portion of the bends are inclined in a downward direction towards the outlet of the coil.

3. The heat exchanger assembly of claim 1, wherein the support members comprise extrusions adapted to increase a contact area between the support members and the coil.

4. The heat exchanger assembly of claim 1, further comprising at least one fin attached to the coil of the heat exchanger assembly.

5. The heat exchanger assembly of claim 4, wherein the fin comprises extrusions adapted to increase a contact area between the fin and the coil.

6. The heat exchanger assembly according to claim 1, wherein the coil is defined by adjacent at least first and second vertical columns each comprising at least one pair of the horizontal rows and the first and second vertical columns are nested so that at least one of the horizontal rows in the first vertical column is in a vertical plane with at least one of the horizontal rows in the second vertical column.

7. The heat exchanger assembly according to claim 1, wherein a first end of the coil comprises horizontal bends and a second end of the coil oppositely-disposed from the first end comprises a first and second set of bends, the first set of bends are inclined in a direction downward and away from the second set of bends and the second set of bends are inclined in a direction downward and away from the first set of bends, and the first and second set of bends alternate to define a herringbone pattern.

8. The heat exchanger assembly according to claim 1, wherein the fluid is CO₂.

9. The heat exchanger assembly according to claim 1, wherein the heat exchanger assembly is adapted to operate at a pressure of up to about 15.2 Mpa.

10. A method of manufacturing the heat exchanger assembly of claim 1, the method comprising the steps of:
bending the tube to form a serpentine shaped tube defined by a plurality of horizontal tube portions in a vertical plane and a plurality of vertical bends at opposite ends of the tube portions and fluidically interconnecting the horizontal tube portions thereof in series, the serpentine shaped tube having an inlet at an uppermost extent thereof and an outlet at a lowermost extent thereof;
bending the serpentine shaped tube about a center axis located at a longitudinal midpoint along the horizontal tube portions to form a coil defined by a plurality of horizontal bends at a first end and the plurality of vertical bends at a second end oppositely disposed from the first end, the plurality of vertical bends defining a first vertical column of vertical bends in a first vertical plane and a second vertical column of vertical bends in a second vertical plane adjacent and parallel to the first column;
twisting each of the plurality of vertical bends in the first column of vertical bends about axes parallel to longitudinal axes of the horizontal tube portions counter clockwise and twisting each of the plurality of vertical bends in the second column of vertical bends about axes parallel to longitudinal axes of the horizontal tube portions clockwise; and then
securing a first support member to the first end of the coil; and then securing a second support member to the second end of the coil oppositely-disposed from the first end of the coil.

11. The method of claim 10, wherein the twisting step comprises twisting each of the plurality of vertical bends in a repeating order comprising:
twisting a first vertical bend in the first column counter clockwise;
twisting a second vertical bend immediately next in fluidic series after the first vertical bend clockwise;
twisting a third vertical bend immediately next in fluidic series after the second vertical bend counter clockwise;
twisting a fourth vertical bend immediately next in fluidic series after the third vertical bend clockwise;
repeating the previous steps until all of the vertical bends have been twisted in series.

12. The method of claim 10, wherein the vertical bends in the first column of vertical bends are twisted about 60 degrees counter clockwise and the vertical bends in the second column of vertical bends are twisted about 60 degrees clockwise.

13. The method of claim 10, further comprising the step of attaching at least one fin to the coil prior to securing the second support member.

14. A method of manufacturing a heat exchanger assembly, the method comprising the steps of:
bending a tube to form a serpentine shaped tube defined by a plurality of horizontal tube portions in a vertical plane and a plurality of vertical bends at opposite ends of the tube portions and fluidically interconnecting the horizontal tube portions thereof in series, the serpentine shaped tube having an inlet at an uppermost extent thereof and an outlet at a lowermost extent thereof;
bending the serpentine shaped tube about a center axis located at a longitudinal midpoint along the horizontal tube portions to form a coil defined by a plurality of horizontal bends at a first end and the plurality of vertical bends at a second end oppositely disposed from the first end, the plurality of vertical bends defining a first vertical column of vertical bends in a first vertical plane and a second vertical column of vertical bends in a second vertical plane adjacent and parallel to the first column;
twisting each of the plurality of vertical bends in the first column of vertical bends about axes parallel to longitudinal axes of the horizontal tube portions counter clockwise and twisting each of the plurality of vertical bends in the second column of vertical bends about axes parallel to longitudinal axes of the horizontal tube portions clockwise; and then
securing a first support member to the first end of the coil; and then securing a second support member to the second end of the coil oppositely-disposed from the first end of the coil.

15. The method of claim 14, wherein the twisting step comprises twisting each of the plurality of vertical bends in a repeating order comprising:
twisting a first vertical bend in the first column counter clockwise;
twisting a second vertical bend immediately next in fluidic series after the first vertical bend clockwise;
twisting a third vertical bend immediately next in fluidic series after the second vertical bend counter clockwise;
twisting a fourth vertical bend immediately next in fluidic series after the third vertical bend clockwise;
repeating the previous steps until all of the vertical bends have been twisted in series.

16. The method of claim 14, wherein the vertical bends in the first column of vertical bends are twisted about 60 degrees counter clockwise and the vertical bends in the second column of vertical bends are twisted about 60 degrees clockwise.

17. The method of claim 14, further comprising the step of attaching at least one fin to the coil prior to securing the second support member.

18. A heat exchanger assembly comprising:
at least one coil adapted to contain a fluid therein and formed of at least one tube comprising:
an inlet at an uppermost extent thereof,
an outlet at a lowermost extent thereof,
a plurality of parallel horizontal rows,
a plurality of bends at opposite ends of the horizontal rows and fluidically interconnecting the horizontal rows thereof in series to define a serpentine configuration, wherein the coil is defined by adjacent at least first and second vertical columns each comprising at least one pair of the horizontal rows and the first and second vertical columns are adjacent each other and nested so that the horizontal rows of the first column and the horizontal rows of the second column are interdigitated with each other; and
at least two support members supporting the coil.

19. The heat exchanger assembly according to claim 18, wherein the coil is adapted to achieve a continuously downward and/or horizontal flow of the fluid therein.

20. The heat exchanger assembly of claim 18, further comprising at least one fin attached to the coil of the heat exchanger assembly.
